(19) United States
(12) Patent Application Publication
(10) Pub. No.: US 2011/0020682 A1
(43) Pub. Date: Jan. 27, 2011

(54) BATTERY COVER ASSEMBLY FOR PORTABLE ELECTRONIC DEVICE

(75) Inventors: HUA-XIANG LIANG, Shenzhen City (CN); YE LIU, Shenzhen City (CN); HSIAO-HUA TU, Shindian (TW)

Correspondence Address: Altis Law Group, Inc.;ATTN: Steven Reiss, 288 SOUTH MAYO AVENUE, CITY OF INDUSTRY, CA, 91789, US

(73) Assignees: SHENZHEN FUTAIHONG PRECISION INDUSTRY CO., LTD., ShenZhen City (CN); FIH (HONG KONG) LIMITED, Kowloon (HK)

(21) Appl. No.: 12/768,686

(22) Filed: Apr. 27, 2010

(30) Foreign Application Priority Data
Jul. 24, 2009 (CN) 200910304823.2

(51) Int. Cl. H01M 2/10

(52) U.S. Cl. 429/97

(57) ABSTRACT

A battery cover assembly for a portable electronic device includes a battery cover, a base body, and a latching member. The battery cover defines a groove. The base body defines two cutouts. The latching member is received in the groove. The latching member includes a main section and two elastic arms. The main section includes two clasps received in the cutouts. The arms are fixed to the groove of the battery cover to allow the battery cover to releasably latch to the base body.

### BACKGROUND

1. Technical Field

The present disclosure generally relates to battery cover assemblies and, particularly, to a battery cover assembly for use in a portable electronic device.

2. Description of Related Art

Batteries are widely used in portable electronic devices, such as personal digital assistants (PDAs), mobile phones, and other devices. Conventional batteries are attachably received in the electronic device, and battery covers are designed to connect with housings of the electronic devices to secure the batteries. Batteries are replaced by opening the battery covers when, for example, the batteries are damaged, exhausted, or no longer rechargeable.

Although battery cover assemblies may be simple, engagement between the battery cover and the housing of the mobile phone can be too firm to be easily separated.

Therefore, there is room for improvement within the art.

### BRIEF DESCRIPTION OF THE DRAWINGS

Many aspects of the battery cover assembly can be better understood with reference to the following drawings. The components in the drawings are not necessarily drawn to scale, the emphasis instead placed upon clearly illustrating the principles of the battery cover assembly. Moreover, in the drawings, like reference numerals designate corresponding parts throughout the several views, in which:

FIG. 1 is an exploded, isometric view of a portable electronic device employing a battery cover assembly in accordance with an exemplary embodiment;

FIG. 2 is similar to FIG. 1, but shown from another aspect;

FIG. 3 is a partially assembled view of FIG. 1;

FIG. 4 is an assembled view of FIG. 1;

FIG. 5 is a cross section of the battery cover assembly of FIG. 3 along line V-V, shown detached; and

FIG. 6 is a cross section of the battery cover assembly of FIG. 3 along line V-V, shown latched.

### DETAILED DESCRIPTION

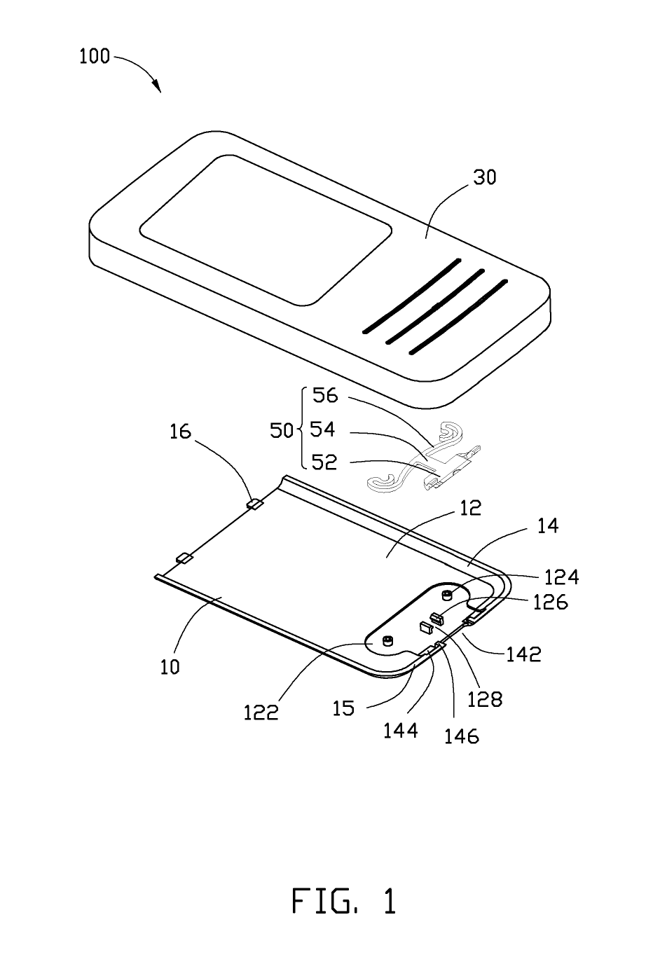

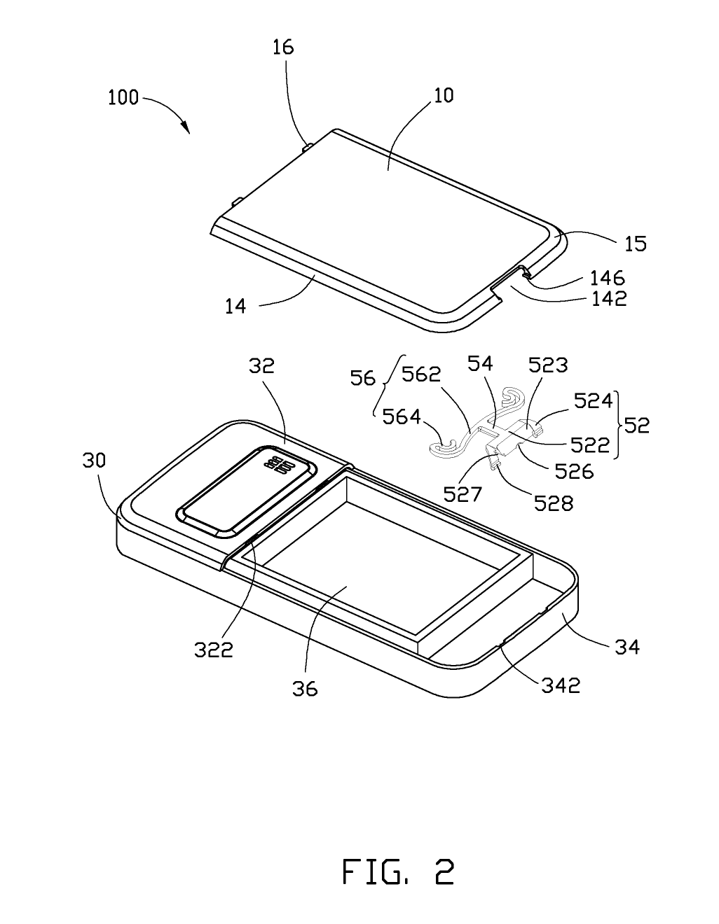

FIGS. 1 and 2 show a portable electronic device 100, such as a mobile phone, employing a battery cover assembly. The mobile phone 100 is an exemplary application, for the purposes of describing details of an exemplary embodiment of a battery cover assembly. The battery cover assembly incorporates a battery cover 10, a base body 30, and a latching member 50. The latching member 50 connects the battery cover 10 to the base body 30, and releasably latches the battery cover 10 to the base body 30.

The battery cover 10 includes a back plate 12, two sidewalls 14, and a connecting wall 15 connecting the two sidewalls 14. The back plate 12 defines a groove 122 at one end thereof adjacent to the connecting wall 15. Two posts 124 and two hooks 126 project from a bottom wall of the groove 122. A distance between the posts 124 exceeds that between the hooks 126. A guide space 128 is defined between the hooks 126. The connecting wall 15 defines an opening 142 communicating with the groove 122. Two slots 144 are defined at two sides of the opening 142. A positioning portion 146 is formed between the opening 142 and each slot 144. Two tabs 16 are formed at another end of the back plate 12 opposite to the connecting wall 15.

The base body 30 includes a first end portion 32, a second portion 34, and two side portions 33, cooperatively defining a cavity 36 for receiving a battery (not shown). The first end portion 32 defines two notches 322 engagable with the tabs 16. The second portion 34 defines two cutouts 342 corresponding to the slots 144 of the battery cover 10.

The latching member 50 is configured to be received in the groove 122, and includes a main section 52, a connecting section 54, and a fixing section 56 integrally formed together. The main section 52 includes a contact portion 522 and two extending portions 524. The contact portion 522 is configured to bee received in the opening 142. An inclined surface 523 is formed at one end of the contact portion 522. A concave 528 is defined in the inclined surface 523 for conveniently operating. The contact portion 522 defines a recess 527 at two sides thereof for latching with the positioning portion 146 to prevent the latching member 50 from separating from the battery cover 10. Each extending portion 524 is angled with the contact portion 522, and includes a clasp 528 configured for received in the slots 144 and the cutouts 322. The connecting section 54 is narrower than the main section 52 configured to be received in the guide space 128 between the hooks 126. The fixing section 56 is disposed at one end of the connecting section 54 opposite to the main section 52. The fixing section 56 includes two J-shape arms 562. Each arm 562 is elastic and extends directly from the connecting section 54. Each arm 562 is bent to a half-S shape at a distal end thereof and thus forms a locking portion 564 configured to latch with the posts 124.

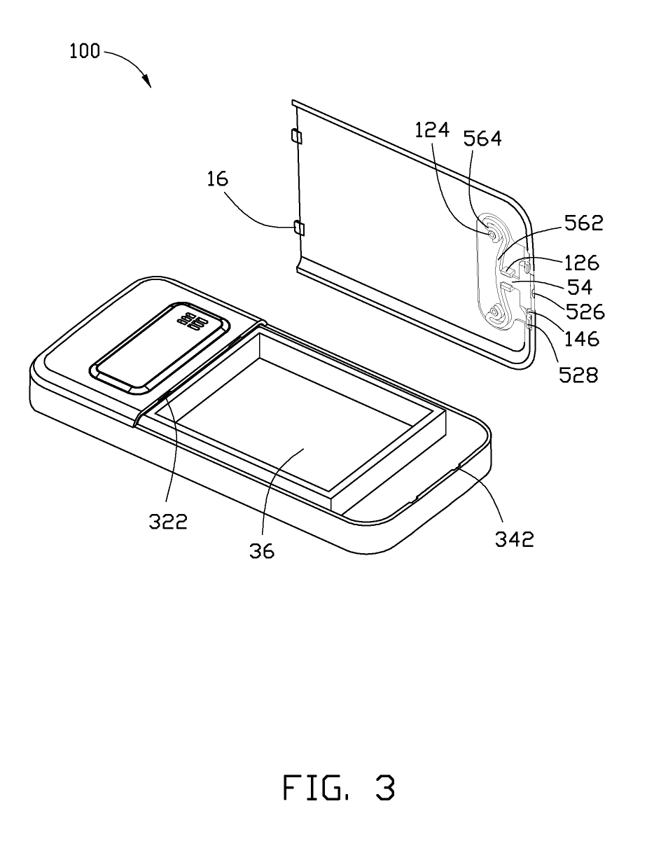

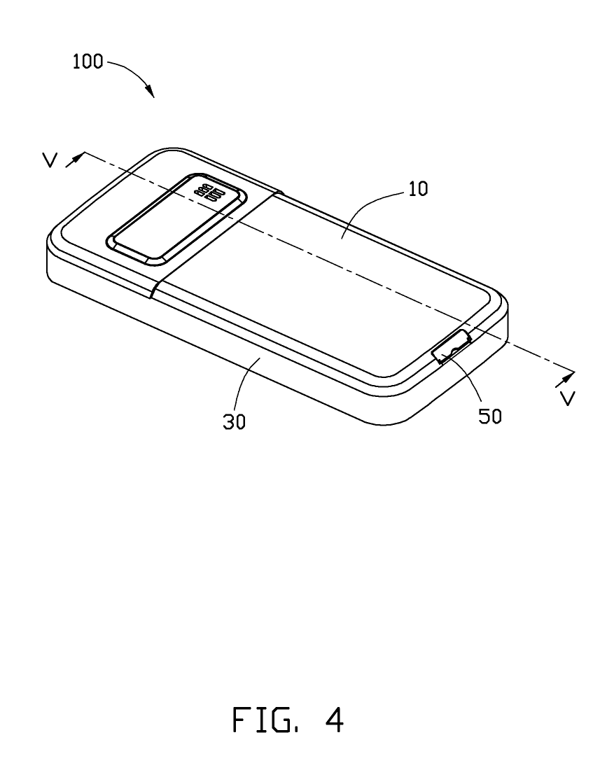

During assembly of the battery cover assembly, referring to FIGS. 3 and 4, first, the latching member 50 is received in the groove 122. The connecting section 54 extends into the guide space 128 between the hooks 126, and the locking portions 564 are latched with the posts 124 allowing the latching member 50 to be attached to the battery cover 10. The main section 52 is received in the opening 142, and the inclined surface 523 is exposed from the opening 142. The extending portions 524 are received in the slots 144, and the claps 528 project from the slots 144 of the battery cover 10. The tabs 16 of the battery cover 10 are received in the notches 322 of the base body 30. The battery cover 10 is pressed downward, and slid toward the tabs 16. The arms 562 are elastically deformed until the claps 528 are latched in the cutouts 342. Thus, the battery cover 10 is assembled in the base body 30.

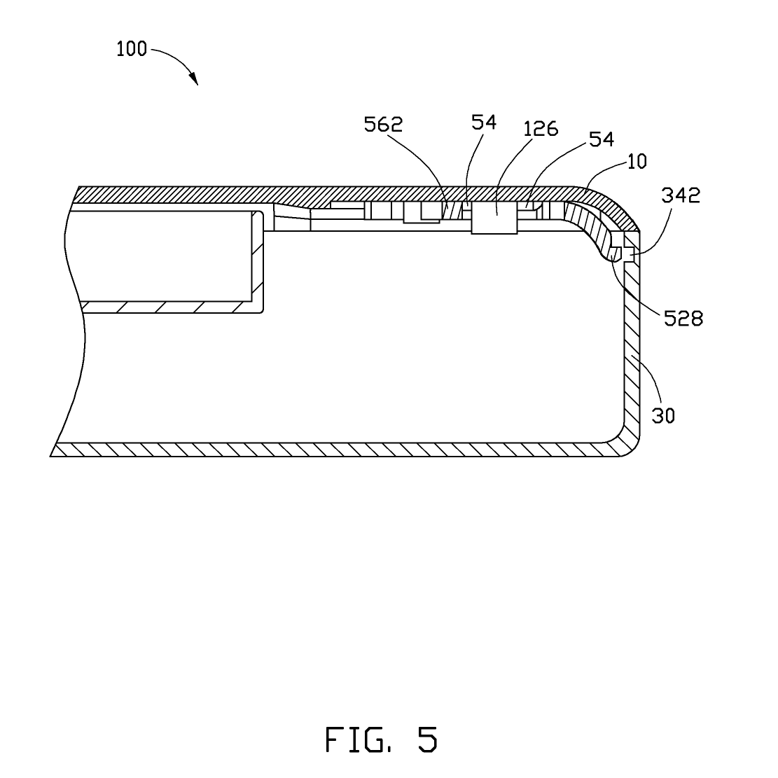

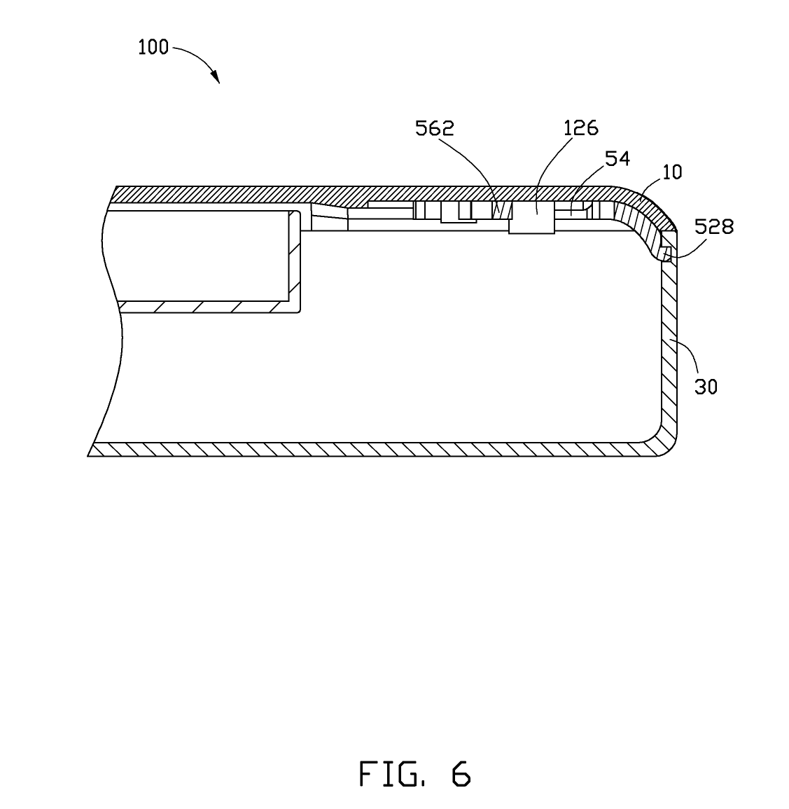

Referring to FIGS. 5 and 6, when the battery cover 10 is to be opened, the inclined surface 523 is pressed. The arms 562 are deformed to allow the clasps 528 to separate from the cutouts 342. The tabs 16 exit from the notches 322 and the battery cover 10 can then be removed.

As described, the exemplary embodiment provides a battery cover assembly for portable electronic devices, such as mobile phones. The battery cover of the battery cover assembly can be easily opened.

It is believed that the present embodiments and their advantages will be understood from the foregoing description, and it will be apparent that various changes may be made thereto without departing from the spirit and scope of the disclosure or sacrificing all of its material advantages, the examples hereinbefore described merely preferred or exemplary embodiments of the disclosure.

What is claimed is:

1. A battery cover assembly for a portable electronic device, the battery cover assembly comprising:
a battery cover defining a groove;
a base body defining two cutouts;
a latching member received in the groove, the latching member including a main section and two elastic arms, the main section including two clasps received in the cutouts, the arms deformedly fixed to the groove of the battery cover to allow the battery cover to releasably latch to the base body.

2. The battery cover assembly as claimed in claim 1, wherein the main section includes a contact portion and two extending portions, each extending portion is angled with the contact portion, the clasps are formed on the extending portions.

3. The battery cover assembly as claimed in claim 2, wherein an inclined surface is formed at one end of the contact portion, and a concave depression is defined in the inclined surface at one end thereof.

4. The battery cover assembly as claimed in claim 2, wherein the contact portion defines a recess at two sides thereof, the battery cover seats two positioning portions received in the recesses.

5. The battery cover assembly as claimed in claim 1, wherein the latching member further includes a fixing section and a connecting section, the arms are formed on the fixing section, and each arm extends directly from the connecting section.

6. The battery cover assembly as claimed in claim 5, wherein each arm is bent to a half-S shape at a distal end thereof to form a locking portion, and two posts are formed in the groove to be received in the locking portions.

7. The battery cover assembly as claimed in claim 5, wherein two hooks are formed in the groove, and the connecting section is latched between the hooks.

8. A portable electronic device comprising:
a battery cover;
a base body defining two cutouts;
a latching member attached to the battery cover, the latching member including a main section and two elastic arms, the main section including two clasps engaging in the cutouts, the arms allow the battery cover to releasably latch to the base body.

9. The portable electronic device as claimed in claim 8, wherein the battery cover includes a back plate, two sidewalls, and a connecting wall connecting the two sidewalls, the back plate defines a groove at one end thereof adjacent to the connecting wall, the latching member is received in the groove.

10. The portable electronic device as claimed in claim 9, wherein two posts and two hooks project from a bottom wall of the groove, a distance between the posts is longer than that between the hooks, a guiding space is defined between the hooks.

11. The portable electronic device as claimed in claim 9, wherein the connecting wall defines an opening communicating with the groove, two slots are defined at two sides of the opening.

12. The portable electronic device as claimed in claim 8, wherein the main section includes a contact portion and two extending portions, each extending portion is angled with the contact portion, and the clasps are formed on the extending portions.

13. The portable electronic device as claimed in claim 8, wherein an inclined surface is formed at one end of the contact portion, a concave is defined in the inclined surface at one end thereof.

14. The portable electronic device as claimed in claim 13, wherein the latching member further includes a fixing section and a connecting section, the arms are formed on the fixing section, each arm extends directly from the connecting section.

15. The portable electronic device as claimed in claim 8, wherein the battery cover defines a groove, each arm is bent to a half-S shape at a distal end thereof to form a locking portion, and two posts are formed in the groove for engaging with the locking portions.
